(19) United States
(12) Patent Application Publication
(10) Pub. No.: US 2008/0214168 A1
(43) Pub. Date: Sep. 4, 2008

(54) Cell phone with Personalization of avatar

(75) Inventors: Kenneth S. Bailey, Newport Beach, CA (US); Christopher Carmichael, Laguna Beach, CA (US)

Correspondence Address: Law Office of Scott C Harris Inc, PO Box 1389, Rancho Santa Fe, CA, 92067, US

(73) Assignee: UBIQUITY HOLDINGS, San Juan Capistrano, CA (US)

(21) Appl. No.: 11/959,076

(22) Filed: Dec. 18, 2007

Related U.S. Application Data
(60) Provisional application No. 60/876,725, filed on Dec. 21, 2006.

(51) Int. Cl. H04M 3/42

(52) U.S. Cl. 455/415

(57) ABSTRACT

An avatar is selected by a user. That avatar is then used as part of their personalized identification information with a call to a remote file. The avatar selected on the local phone is displayed on the remote phone when calling.

The present application claims priority from Provisional application No. 60/876,725 filed Dec. 21, 2006, the disclosure of which is herewith incorporated by reference herein.

### BACKGROUND

Popular entertainment often includes discrete moments that form the basis for popular reenactments, such as quotes. Throughout recorded history, lines, speeches and remarks made by famous people often become quotes. The length of time of the popularity varies, however. Some of these things remain popular for many years, others last for much less time.

Quotes from movies, such as “make my day” or “hasta la vista baby” have become popular and then faded from popularity.

### SUMMARY

The present application describes the use of popular quotes as part of a communication over a cellular network.

### BRIEF DESCRIPTION OF THE DRAWINGS

### In the Drawings

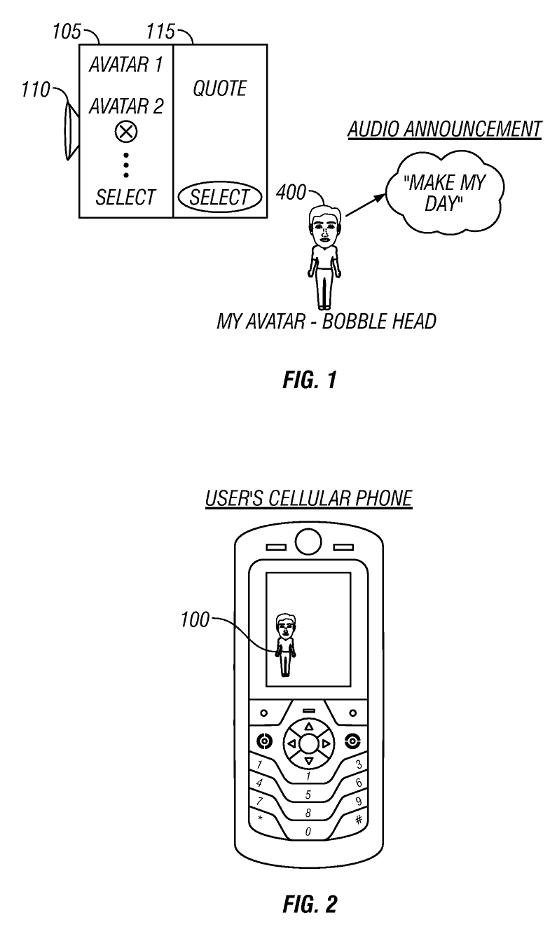

FIG. 1 shows an embodiment with a bobble-head avatar; and

FIG. 2 shows a user's cellular phone showing the avatar thereon.

### DETAILED DESCRIPTION

An embodiment is shown in FIG. 1. A user defines their own “avatar” 100 that is used when they send messages or information to another cellular phones. The avatar may be selected by the customer from a list of possible avatars shown as 105. The avatar can also be customized. For example, the mobile phone may include a camera 110 that can be used to obtain a picture of the user's face. The face can be superimposed over the avatar's face, or a caricature face of the avatar can be used.

A user can also select a popular phrase or quote to accompany the caricature/avatar. The phrase or quote may be selected by the actual user from the list of quotes 115, or may be recorded in the user's own voice. In one embodiment, the quote is sent as part of an initiated call, when the caller connects to the other person's cellular phone. For example, a user 1 may call user x. User 1 has defined their quote as being “make my day” from the popular Clint Eastwood movie, and has defined an avatar that may look like Clint Eastwood. The user can reset their avatar/picture/quote whenever they want—e.g., any time that they have a new favorite or popular quote or picture. Hence, this allows following the fad, however the user prefers to do so.

The new picture is selected to be representative of the calling user. When user 1 calls to user x or to any other user, the user x sees the avatar—e.g. a picture selected by user 1, or representing the user 1 in some other way. The picture can be customized via the avatar. The avatar identifies the caller to the called party, both by caricature and by playing back the selected quote.

FIG. 2 illustrates the bobble head 100, indicating the selection that has been currently made by the calling party, on a screen of the phone of the called party.

This is different than the prior art in many ways. The prior art, for example, has allowed the recipient to choose ring tones, photos, etc for the callers. In contrast, this system allows a user to choose how others see him, and to change that whenever desired. Every time that the user selects different information, that different information is sent to the receiver, and appears on their phone as part of the call.

The caller pays for using this system in different ways. For example, the cellular network can require payment in order to download the avatars and quotes. The user may also require that the avatars be uploaded each time a call is made; in which case the customer may pay a fee, for example, for the bandwidth used for sending the information. This fee can be split between the copyright holder and a cellular carrier, or can be split in some other way.

In one embodiment, the customized avatar is used each time the user desires to send any communication. In another embodiment, however, the user can select different avatars to send to different people. For example, the avatar x can be used for all people except those on the user's contact list, and there can be a default avatar for those on the contact list, and specific avatars for those on the contact list, as desired. This enables users to send unique identifiers to each other if they are known to one another.

Another embodiment describes that the avatars are animated like bobble heads. A bobble head is a small doll with the head of a person attached to a spring. In a car, as the car moves, the head bobbles between different sides. The electronic form of the bobble head moves around the video screen or cellular phone screen to capture the user's head motion. The avatar, which is a cartoon in this version of the bobble head, is used for this purpose. For example, a bobble head may be created using a cellular phone's internal digital camera. This can be defined as a bobble head avatar to be used in one of the different ways disclosed above.

Once the bobble head is defined in this way, it can be displayed on the camera of the cellular phone, and used as a caller ID image of the person. Whenever the user calls a number, their selected bobble head is sent along with the call, and seen by the call recipient. The bobble may be caused to move around on the screen, and to have its head also move around, like an analog bobble head.

In another embodiment, the image is reduced to a caricature. The user can send this reduced caricature image to the remote phone. The caricature can use an automated system that automatically cartoonizes a picture, or can use a more manual technique. The caricature image then announces the caller along with, for example, the quotes, which may be in the user's actual voice.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other image forms and selections can be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

The operations and/or flowcharts described herein may be carried out on a computer, or manually. If carried out on a computer, the computer may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop. Moreover, the method steps and operations described herein can be carried out on a dedicated machine that does these functions.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method, comprising:
allowing a user to select, on their portable communication device, information including at least an avatar image to be sent to a remote user associated with a communication that is sent to the remote user;
initiating a communication using the portable communicator device;
sending said information to the remote user as part of the communication; and
allowing the user to change the information to thereafter cause the changed information as part of the communication.

2. A method as in claim 1, wherein said information also includes a quote formed of a phrase of words spoken by a specified person.

3. A method as in claim 1, wherein said avatar image is selected from a catalog of images.

4. A method as in claim 3, wherein said avatar image is also customized using an image of the user, and wherein said customized avatar image includes a portion of the image from the catalog and a portion representing an actual image of the user.

5. A method as in claim 1, wherein said avatar image is customized as a bobble head with a head portion that moves between different orientations.

6. A method as in claim 1, wherein the user selects the avatar from a catalog of avatars, and further comprising allowing the user to download additional avatars to the catalog.

7. A method, comprising:
on a portable phone, obtaining an image using an internal camera of a phone;
using the image to customize information on the portable phone, wherein said customized information includes personalized information that is personalized using said image;
associating said personalized information with at least one called contact, using the portable phone; and
calling at least one of the contacts on the phone, and causing the personalized information to be viewed by said at least one contact on their remote phone, said viewing comprising showing said customized information on the screen of the phone.

8. A method as in claim 7, further comprising selecting a quote on the portable phone, and said calling comprises displaying the quote on the remote phone.

9. A method as in claim 7, wherein said customizes further comprises causing a head within said image to bobble.

10. A method, comprising:
selecting an avatar on a local phone;
associating the avatar with a remote phone;
displaying the avatar on the remote phone when the local phone calls the remote phone.

11. A method as in claim 10, further comprising customizing the avatar on the local phone, and thereafter displaying a customized version of the avatar on the remote phone when the local phone calls the remote phone.

12. A method as in claim 11, wherein said customizing comprises adding a picture of a user of the local phone to a portion of the avatar that is selected.

13. A method as in claim 11, wherein said customizing comprises causing a head of the avatar to bobble.
